(19) United States
(12) Patent Application Publication
(10) Pub. No.: US 2025/0249528 A1
(43) Pub. Date: Aug. 7, 2025

(54) BATTERY CELL CURRENT COLLECTOR STRAIGHT TAB WELDING

(71) Applicant: GM Global Technology Operations LLC, Detroit, MI (US)

(72) Inventors: Matthew Arthur Celentano, Berkley, MI (US); John Christian Kalil, Washington, MI (US); Reza Kavian, Sterling Heights, MI (US); Masoud Mohammadpour, Novi, MI (US); Seung-Woo Chu, Sterling Heights, MI (US)

(21) Appl. No.: 18/434,012

(22) Filed: Feb. 6, 2024

(51) Int. Cl. B23K 20/10; B23K 26/21; H01M 50/533; H01M 50/536; H01M 50/54

(52) U.S. Cl. CPC B23K 20/10; B23K 26/21; H01M 50/533; H01M 50/536; H01M 50/54

(57) ABSTRACT

A system for electrically connecting tabs of a battery cell includes an electrically conductive weld plate configured to be disposed within a housing of the battery cell and electrically connected to a tab stack formed from a plurality of tabs extending from electrode layers of a cell stack, the weld plate having a welding surface that is at least partially oriented along a vertical direction, the vertical direction parallel to a surface of electrode layers forming an electrode stack, and a welding device configured to weld the tab stack to the welding surface and form at least part of a connector. The tab stack is welded while maintaining the tab stack in a planar configuration and in an undeformed condition.

### INTRODUCTION

The subject disclosure relates to batteries, and more particularly to manufacture and assembly of battery cells.

Battery cells are used in various applications, such as automotive applications (e.g., in electric and hybrid vehicles). For example, electric and hybrid vehicle battery systems include battery modules having multiple battery cells. Battery cells may be prismatic-type cells or other types of cells, and typically include multiple layers of both anode material and cathode material. Anode layers are electrically connected by welding a stack of anode tabs, and cathode layers are electrically connected by welding a stack of cathode tabs.

### SUMMARY

In one exemplary embodiment, a system for electrically connecting tabs of a battery cell includes an electrically conductive weld plate configured to be disposed within a housing of the battery cell and electrically connected to a tab stack formed from a plurality of tabs extending from electrode layers of a cell stack, the weld plate having a welding surface that is at least partially oriented along a vertical direction, the vertical direction parallel to a surface of electrode layers forming an electrode stack, and a welding device configured to weld the tab stack to the welding surface and form at least part of a connector. The tab stack is welded while maintaining the tab stack in a planar configuration and in an undeformed condition.

In addition to one or more of the features described herein, the undeformed condition is a condition in which the tab stack is not folded prior to welding, and is not subject to bending forces during the welding.

In addition to one or more of the features described herein, the welding device is configured to perform a welding method that includes at least one of ultrasonic welding and laser welding, the welding device including at least one of a laser welding device and an ultrasonic welding device, the ultrasonic welding device including an ultrasonic generator configured to engage the tab stack and the welding surface.

In addition to one or more of the features described herein, the welding surface includes a textured pattern to facilitate fusion of the tab stack to the weld plate.

In addition to one or more of the features described herein, the tab stack includes a first tab stack and a second tab stack formed from the plurality of tabs, and the welding surface includes a pair of opposing weld surfaces, each opposing weld surface configured to be used to weld one of the first tab stack and the second tab stack to the weld plate.

In addition to one or more of the features described herein, the system includes an actuator configured to move the weld plate in the vertical direction, the actuator being controllable to move the weld plate toward the cell stack in the vertical direction subsequent to welding, to relieve stress on portions of the plurality of tabs between the cell stack and the tab stack.

In addition to one or more of the features described herein, the housing is a rigid housing.

In addition to one or more of the features described herein, the system includes a bonding device configured to engage the plurality of tabs and bond the plurality of tabs together in the planar configuration to form the tab stack.

In another exemplary embodiment, a method of electrically connecting tabs of a battery cell includes acquiring a cell stack, the cell stack configured to be disposed in a housing to form the battery cell, where a plurality of tabs extend from electrode layers of the cell stack, and forming a tab stack from a portion of the plurality of tabs, and disposing the tab stack against a welding surface of a weld plate, the weld plate configured to be disposed within the housing, the welding surface at least partially oriented along a vertical direction, the vertical direction parallel to a surface of electrode layers forming an electrode stack. The method also includes welding the tab stack to the welding surface by a welding device to form at least part of a connector, where the tab stack is welded while maintaining the tab stack in a planar configuration and in an undeformed condition.

In addition to one or more of the features described herein, the undeformed condition is a condition in which the tab stack is not folded prior to welding, and is not subject to bending forces during the welding.

In addition to one or more of the features described herein, the welding device is configured to perform a welding method that includes at least one of ultrasonic welding and laser welding, the welding device including at least one of a laser welding device and an ultrasonic welding device, the ultrasonic welding device including an ultrasonic generator configured to engage the tab stack and the welding surface.

In addition to one or more of the features described herein, the welding surface includes a textured pattern to facilitate fusion of the tab stack to the weld plate.

In addition to one or more of the features described herein, the tab stack includes a first tab stack and a second tab stack formed from the plurality of tabs, the welding surface includes a pair of opposing weld surfaces, and welding the tab stack includes welding the first tab stack to one of the pair of opposing surfaces and welding the second tab stack to another of the pair of opposing surfaces.

In addition to one or more of the features described herein, the method includes moving the weld plate toward the cell stack in the vertical direction subsequent to welding, to relieve stress on portions of the plurality of tabs between the cell stack and the tab stack.

In addition to one or more of the features described herein, the method includes diverting an excess portion of the plurality of tabs, the excess portion including portions of each tab above the welded tab stack, wherein the diverting includes applying a curvature to the excess portion.

In yet another exemplary embodiment, a computer program product includes a computer-readable memory that has computer-executable instructions stored thereupon, the computer-executable instructions when executed by a processor cause the processor to perform operations. The operations include acquiring a cell stack, the cell stack configured to be disposed in a housing to form a battery cell, where a plurality of tabs extend from electrode layers of the cell stack, forming a tab stack from a portion of the plurality of tabs, and disposing the tab stack against a welding surface of a weld plate, the weld plate configured to be disposed within a housing of the battery cell, the welding surface at least partially oriented along a vertical direction, the vertical direction parallel to a surface of electrode layers forming an electrode stack. The operations also include welding the tab stack to the welding surface by a welding device to form at least part of a connector, where the tab stack is welded while maintaining the tab stack in a planar configuration and in an undeformed condition.

In addition to one or more of the features described herein, the undeformed condition is a condition in which the tab stack is not folded prior to welding, and is not subject to bending forces during the welding.

In addition to one or more of the features described herein, the welding device includes an ultrasonic welding device, including an ultrasonic generator configured to engage the tab stack and the welding surface, and the welding surface includes a textured pattern to facilitate fusion of the tab stack to the weld plate.

In addition to one or more of the features described herein, the operations include moving the weld plate toward the cell stack in the vertical direction subsequent to welding, to relieve stress on portions of the plurality of tabs between the cell stack and the tab stack.

In addition to one or more of the features described herein, the operations include engaging the plurality of tabs by a bonding device, and bonding the plurality of tabs together in the planar configuration to form the tab stack prior to welding.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an example of a battery cell;

FIG. 2 depicts an example of a battery cell;

FIG. 3 depicts a system for manufacturing a battery cell, in accordance with an exemplary embodiment;

FIG. 4 depicts components of a battery cell and components of a system for electrically connecting tabs of a battery cell, in accordance with an exemplary embodiment;

FIGS. 5A and 5B depict components of a battery cell and components of a system for electrically connecting tabs of a battery cell, in accordance with an exemplary embodiment;

FIGS. 6A-6F depict aspects of a method of electrically connecting battery cell tabs and manufacturing a battery cell;

FIG. 7 depicts an example of a laser welding process used to join tab stacks of a battery cell to a weld plate of the system of FIG. 4;

FIG. 8 depicts an example of a laser welding process used to join tab stacks of a battery cell to a weld plate of the system of FIG. 4;

FIG. 9 depicts an example of a combination laser and ultrasonic welding process used to join tab stacks of a battery cell to a weld plate of the system of FIG. 4;

FIG. 10 depicts components of a battery cell and components of a system for electrically connecting tabs of a battery cell, the system including a connection assembly having a diversion feature for diverting excess tab portions, in accordance with an exemplary embodiment;

FIG. 11 depicts components of a battery cell and components of a system for electrically connecting tabs of a battery cell, the system including a connection assembly having a diversion device for diverting excess tab portions, in accordance with an exemplary embodiment; and

FIGS. 12A-12F depict aspects of a method of diverting excess tab portions using the diversion device of FIG. 11, electrically connecting battery cell tabs and manufacturing a battery cell, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for facilitating attachment and electrical connection of electrodes (anodes and cathodes) in a battery cell. An embodiment of a system for consolidating and joining portions of electrodes or electrode layers includes a connection assembly configured to perform functions related to forming battery tab stacks, welding tab stacks and forming connectors for a battery cell.

An embodiment of the connection assembly includes an internal terminal weld plate (also referred to as an internal weld plate) configured to weld tabs in a tab stack together while the tab stack is in a planar form. The tab stack is in a “planar form” when the tab stack (or at least a portion of the tab stack subject to welding) is vertically or otherwise linearly oriented. The tab stack can thus be welded or joined without folding any portion of the tab stack (e.g., any portion subject to the weld), and without deformation due to bending forces. Excess tab portions (i.e., portions above a weld) may be dealt with by trimming, diversion or other suitable technique(s).

The internal weld plate defines one or more flat or planar welding surfaces configured to maintain the tab stack in a planar and/or undeformed condition during welding. In an embodiment, the tab stack is welded via ultrasonic welding, and the welding surfaces each include a textured surface for increasing the quality of the weld.

The internal weld plate may include additional features, such as rounded edges, to avoid tearing or other damage to the tabs. The internal weld plate may be connected to an actuator for moving the weld plate prior to and/or subsequent to welding. For example, the weld plate can be moved in an upward direction (away from a cell stack) to provide tension and ensure that the tabs making up a tab stack are properly aligned, and moved in a downward direction after welding for strain relief (e.g., by allowing portions of the tabs between the tab stack and the cell stack to curve and providing slack to alleviate stress). An “upward” direction is defined herein as a direction that points away from a battery cell stack (e.g., parallel to electrode layers in the cell stack or along a plane defined by an electrode layer surface) and a “downward” direction is defined as a direction that points toward the cell stack (e.g., parallel to the electrode layers or along the plane defined by an electrode layer surface).

Embodiments described herein present numerous advantages and technical effects. The embodiments provide for an improved manufacturing process that facilitates proper attachment and electrical connection of electrode tabs. For example, embodiments described herein allow for forming and welding tab stacks without the need for folding, which reduces the potential for tearing or other damage. In addition, embodiments reduce the stresses on tab layers when welding.

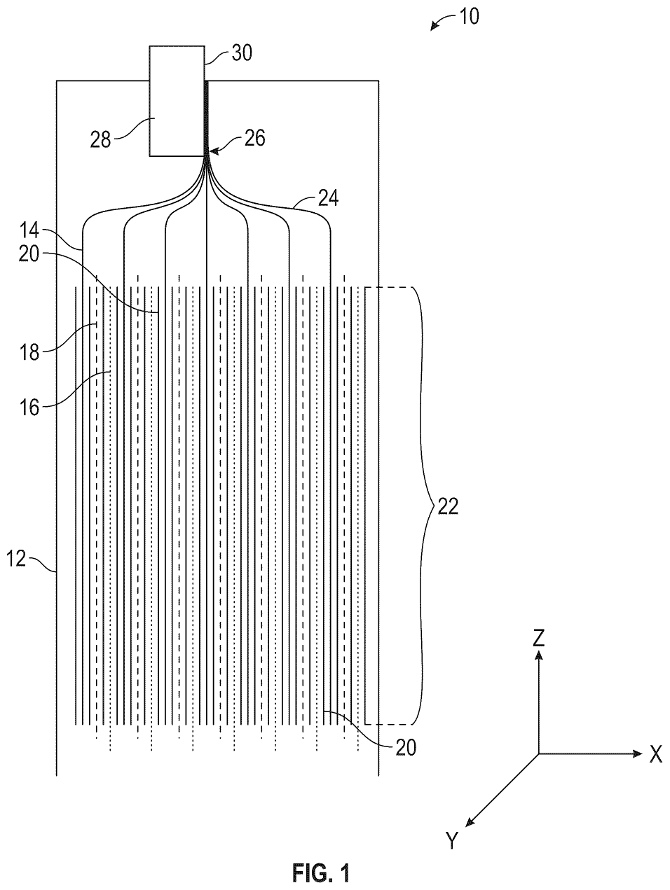

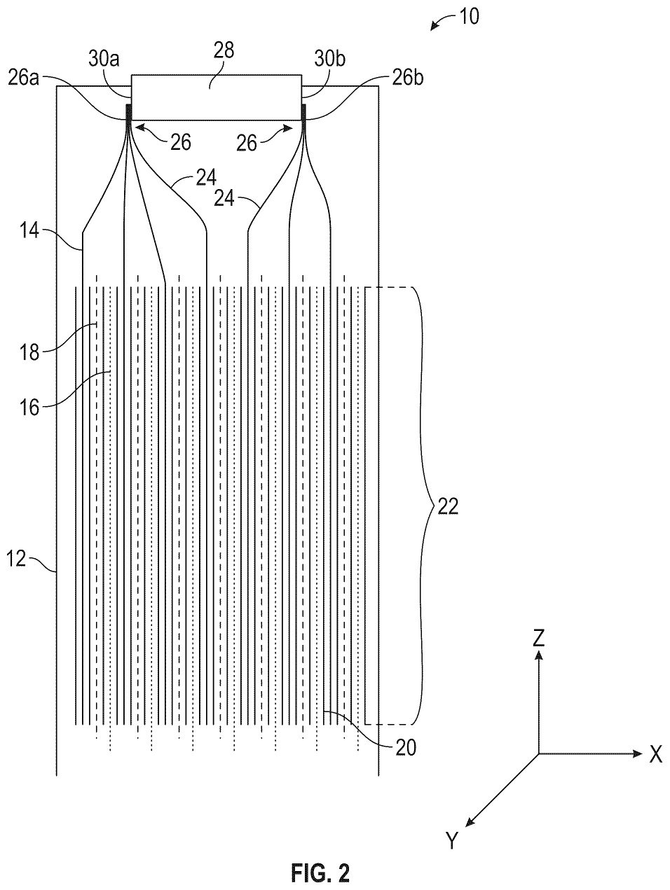

FIGS. 1 and 2 depict examples of a battery cell 10. The battery cell includes a housing 12, which may be a rigid housing designed for a prismatic cell. For example, the housing is a rectangular housing or “can” made from aluminum or other material. Embodiments described herein are not limited to any particular type of battery cell, or any particular shape, size or material of the electrodes and the housing. For example, embodiments may be applicable cells having various types of housings.

The battery cell 10 includes a plurality of layers that form negative electrodes or anodes, and positive electrodes or cathodes. The anodes are made from electrically conductive anode layers 14, and the cathodes are made from electrically conductive cathode layers 16. The anode layers 14 and the cathode layers 16 are configured as thin sheets or foils. A separator 18 made from an electrically insulating material (e.g., polymer or ceramic) is disposed between each anode layer 14 and adjacent cathode layer 16. An active material 20, such as a graphite or a material including Lithium, is disposed in the housing 12 between the various layers. These internal layers constitute a battery cell stack 22.

It is noted that the number of electrodes is not limited to the number shown in FIG. 1. The battery cell 10 may have any number of anode layers 14 and any number of cathode layers 16. For example, the battery cell 10 may have hundreds of individual foil layers forming the electrode layers.

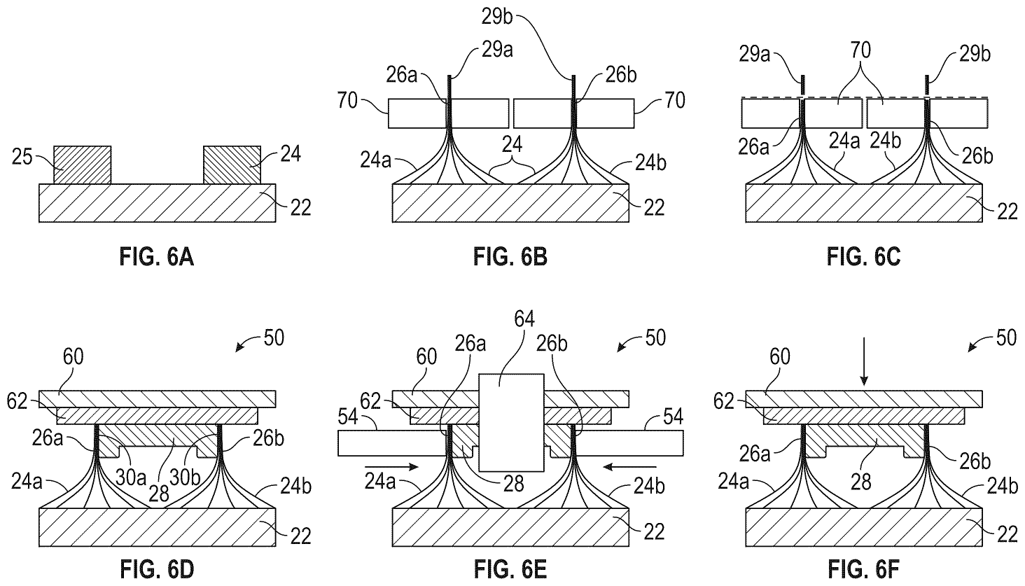

As shown in FIG. 1, each anode layer 14 includes a portion 24 that extends away from the interior of the cell 10 and allows for electrical connection of each anode layer 14 with another anode layer 14. This portion 24 is also referred to as a tab 24 or connection tab 24. Although not shown, the cathode layers 16 include tabs so that the cathode layers 16 can be connected. The cathode layer tabs (not shown) may extend from an end opposite to the anode tabs 24 (in the z-direction) or extend from the same end (e.g., as shown in FIG. 6A).

Portions of the tabs 24 (or a subset thereof) are stacked together as at least one tab stack 26. The portions making up each tab stack 26 are welded together by, for example, a primary ultrasonic weld. In an embodiment, the weld is a solid-state weld joint formed through ultrasonic welding. The cell 10 is not so limited, as other techniques may be used, such as laser welding and other metal-to-metal joining procedures.

Each tab stack 26 is welded to an electrically conductive component 28 (“weld plate”) that provides a contact point for welding the tab stack 26 together and may serve as at least part of a connector. The connector forms a negative terminal. The cathode layers 16 may be similarly welded to a positive terminal (not shown) that extends to an exterior of the housing 12. The weld plate 28 may form the connector, either exclusively or in combination with other conductive bodies.

The weld plate 28 includes at least one welding surface 30. The welding surface 30 serves as a base and provides welding contacts where the tab stack 26 is fused to the weld plate 28. Each welding surface 30 is configured to provide a base that allows the tab stack 26 to be welded without folding, deflecting or otherwise applying bending forces (as opposed to tensile forces, which may be applied during welding) the portions making up the tab stack (i.e., the portions that are fused to one another and the weld plate 28). In an embodiment, each welding surface 30 is a generally planar surface, which may have features disposed on the surface or integral with the surface (e.g., to facilitate ultrasonic welding and described further herein).

FIG. 1 shows an example in which the tabs 24 are gathered and joined as a single tab stack 26 for the anode layers 14 (a single tab stack for connection of the cathode layers may be similarly formed). FIG. 2 shows an example in which the tabs 24 are gathered into two separate tab stacks 24 (denoted as tab stacks 24a and 24b) that are each welded to a respective surface 30 (denoted as surfaces 30a and 30b).

As discussed further herein, each surface 30 (a single surface 30 or the surfaces 30a and 30b) is a planar surface, which may be oriented along a vertical direction (z-axis), such that each surface 30 is at least substantially parallel to surfaces of the electrode layers. Each surface 30 may be entirely or substantially vertical, or may be oriented at an angle with respect to the vertical direction (less than 90 degrees relative to the cell stack). In this way, each tab stack 26 is formed or welded such that folding is avoided, in contrast to conventional manufacturing processes.

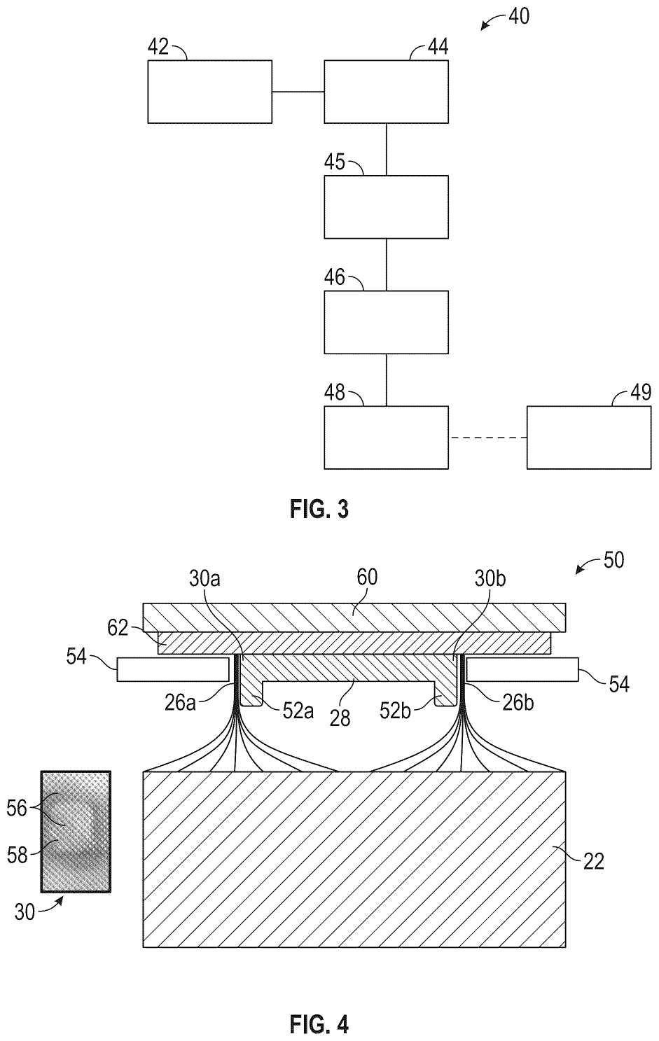

FIG. 3 depicts an example of a manufacturing system 40 for manufacturing battery cells. The manufacturing system 40 includes various manufacturing stations, which may be controlled or operated by a computer system, a human operator or a combination thereof. As described herein, a “station” refers to any number, combination and layout of equipment and is not intended to limit the manufacturing system 40 to any specific machine or combination of machines.

The manufacturing system 40 includes, for example, an active material processing station 42 for preparing active materials to be applied to electrode layers. The system 40 may also include a coating station 44 for coating electrodes with the active materials. The manufacturing system 40 also includes an electrode cutting station 45, which can be used to form electrode layers and tabs from sheets of electrode material (e.g., copper and aluminum sheets).

The system 40 also includes a stacking station 46 for forming the various layers of a battery stack, and a welding station 48 for welding electrode layer tabs. The welding station 48 may include the weld plate 28 as described herein, in combination with welding equipment.

The system 40 may include, or be connected to, one or more processing devices for performing various aspects of manufacturing. For example, the welding station 48 is connected to a controller 49 for control of processes such as bonding, trimming, diversion of excess tab portions and/or welding.

The system 40 may include other stations for performing subsequent processes to complete battery cells. Examples include an assembly station (e.g., for cell package or housing construction, sealing, electrolyte filling, etc.), and stations for manufacturing battery assembles, such as battery packs and/or modules.

For example, battery cells can be installed in a battery assembly. The battery assembly may be a battery module having a plurality of electrically connected battery cells, such as a battery module that is incorporated into a vehicle (e.g., an electric or hybrid vehicle) as part of a battery pack.

FIG. 4 depicts components of an embodiment of a system for electrically connecting the tab stacks to weld plates or other connectors. The system includes a tab connection assembly 50, which includes the weld plate 28. In this embodiment, the weld plate 28 is an internal terminal weld plate 28 configured to be disposed within a housing (e.g., the prismatic housing 12 of FIGS. 1 and 2).

The weld plate 28 defines one or more connection members 52, which are elongated in the vertical direction and provide a welding surface 30. There may be one connection member 52, opposing connection members 52a and 52b as shown or any desired number.

For example, each connection member 52a, 52b defines a respective welding surface 30a, 30b that extends vertically and is parallel to the surfaces of the cell stack 22. The welding surface 30a, 30b may be partially parallel, and thus may define an angle of less than 90 degrees with respect to the cell stack surfaces. Each connection member 52a, 52b may have rounded edges or be otherwise configured so that there are no sharp edges that could cause tearing.

In an embodiment, each welding surface 30a, 30b is provided to facilitate ultrasonic welding. Ultrasonic welding typically includes the use of a sonotrode 54 to apply high frequency ultrasonic acoustic vibrations. Each surface 30a, 30b functions as a contact surface (anvil), and a tab stack 26 is held between the sonotrode 54 and the surface 30 when welding.

To increase the quality of an ultrasonic weld, each welding surface 30a, 30b includes one or more features integrated therewith, which function to increase the quality of the bond formed by the welding process. For example, as shown in FIG. 4, the surface 30 includes a textured pattern 56 of bumps, grooves, ridges, protrusions, divots, or other surface features. The surface 30a may also include a raised region 58 corresponding to the area of the weld. The surface 30b may also have a similar pattern 56.

Subsequent to completion of a welding process, a connector formed from a conductive material (and configured to provide an electrical connection between the anode layers and a device to be powered) can be connected to the weld plate 28.

In an embodiment, connection assembly 50 includes the weld plate 28 and one or more additional components attached to (or integral with) the weld plate 28. All of the components of the connection assembly 50 are moveable as a unit.

For example, the connection assembly 50 includes the weld plate 28 and an attached cap plate 60 that forms part of a cover of a battery assembly. Other components (e.g., an isolation insert 62, feedthroughs, terminals, etc.) may also be coupled with the weld plate 28 to form the connection assembly 50.

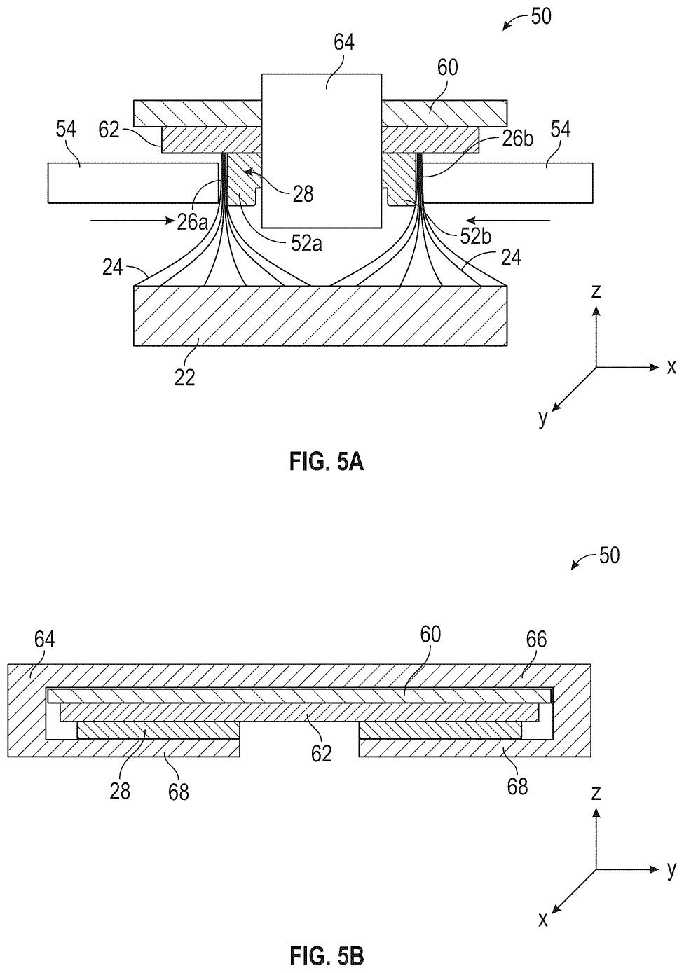

FIGS. 5A and 5B depict an embodiment of the connection assembly 50, which includes a retaining device 64. FIG. 5A is a cross-section along an x-z plane defined by the x-axis and the z-axis, and FIG. 5B is a cross-section along a y-z plane defined by the y-axis and the z-axis.

The retaining device 64 is configured to be disposed around portions of the weld plate 28, the cap plate 60 and the insert 62. As shown in FIG. 5B, the retaining device 64 includes an upper plate 66 and opposing arms 68 that hold the weld plate 28, the cap plate 60 and the insert 62 in place, for example, during welding. The retaining device 64 can be removed after welding by sliding the retaining device 64 along the x-axis.

FIGS. 6A-6F illustrates aspects of a method of manufacturing a battery cell. The method (or parts thereof) may be performed by any suitable processing device or devices, such as one or more controllers of the manufacturing system 40 (e.g., the controller 49 connected to the welding station 48) and/or the connection system 50, but is not so limited.

The method includes a number of steps or stages. The method is not limited to the number or order of steps therein, as some steps may be performed in a different order than that described below, or fewer than all of the steps may be performed.

The method is described in conjunction with forming a tab stack from anode tabs and welding anode tabs to an anode weld plate. It is understood that the method is similarly applicable to cathode tabs.

At a first stage, referring to FIG. 6A, electrodes are created or acquired, which include anode sheets and cathode sheets made from a coated conductive material. For example, the anode sheets are made from copper, and the cathode sheets are made from aluminum.

Anode and cathode sheets are coated, cut, trimmed and/or otherwise processed to create anode and cathode layers, and the anode layers and cathode layers are assembled with other layers (e.g., separator layers) to form the cell stack 22. Each anode and cathode layer has a respective tab extending from the cell stack.

As shown in FIG. 6A, the anode tabs 24 and cathode tabs 25 extend from the same end or side of the cell stack 22. The method is not so limited, as the anode and cathode tabs may extend from opposites ends or sides, or be otherwise positioned as desired.

At a second stage, referring to FIG. 6B, the anode tabs 24 are partitioned into two sets of tabs 24a and 24b. Each set of tabs 24a and 24b is inserted through a bonding device having sets of grippers 70. A portion of each set of tabs disposed between a set of grippers forms a tab stack 26a, 26b. Portions of the sets of tabs above the grippers 70 are referred to as excess portions 29a, 29b. Each set of grippers 70 includes opposing bodies having flat ends, which are brought together to compress a respective tab stack 26a, 26b to bond the tab layers together as flat stacks. The tab stacks may be bonded via compression, application of heat and/or other suitable technique.

At a third stage, referring to FIG. 6C, excess portions 29a, 29b of the tabs 24a, 24b above the bonded tab stacks 26a, 26b are trimmed so that all of the tabs terminate at substantially the same position. Alternatively, the portions may be left in place, and trimmed or folded after the welding process is completed. In an embodiment, the excess portions are diverted as discussed further herein.

At a fourth stage, referring to FIG. 6D, the connection assembly 50 is introduced, and the tab stacks 26a, 26b are disposed against respective surfaces 30a, 30b.

At a fifth stage, referring to FIG. 6E, a welding device is applied to weld the tab stacks 26a and 26b to their respective surfaces. The connection assembly 50 may be moved upwardly away from the cell stack 22 (z-direction) to hold the tab stacks taught while the welding is performed.

In an embodiment, the welding device is an ultrasonic welder including the opposing sonotrodes 54. Each sonotrode 54 is applied to hold a tab stack 26 in place against a welding surface 30a, 30b. The sonotrodes 54 may be activated together as a single weld process. As discussed herein, the welding surfaces 30a, 30b may have textured patterns integrated with the surfaces.

At a sixth stage, referring to FIG. 6F, the sonotrodes 54 are removed. The connection assembly 50 may be moved toward the cell stack 22 to provide strain relief to the portions of the tabs 24 between the tab stacks 26a, 26b and the cell stack 22.

Additional steps or stages may be performed to complete assembly of the battery cell 10, such as installing the welded electrodes in a housing (e.g., pouch or rigid housing) with separator layers, quality inspection, electrolyte filling, housing sealing and others.

The battery cell 10 may be installed in a battery assembly, such as a battery pack or battery module. For example, the battery cell 10 is installed in a battery module with other cells, and the battery module is installed in an electric or hybrid vehicle.

It is noted that the manufacturing system 40, the connection assembly 50 and the method 80 are not intended to limit embodiments to any specific manufacturing process. Any suitable manufacturing system or process that includes some form of cell tab creation and electrical connection may be used.

As discussed, the tab stacks 26a and 26b may be welded to their respective surfaces 30a and 30b via ultrasonic welding, but are not so limited, as any suitable welding or connection technique may be used. Examples of other suitable joining techniques include laser welding, arc welding, mechanical joining, adhesives and combinations thereof. In an embodiment, the tab stacks 26a, 26b are joined via ultrasonic and/or laser welding processes.

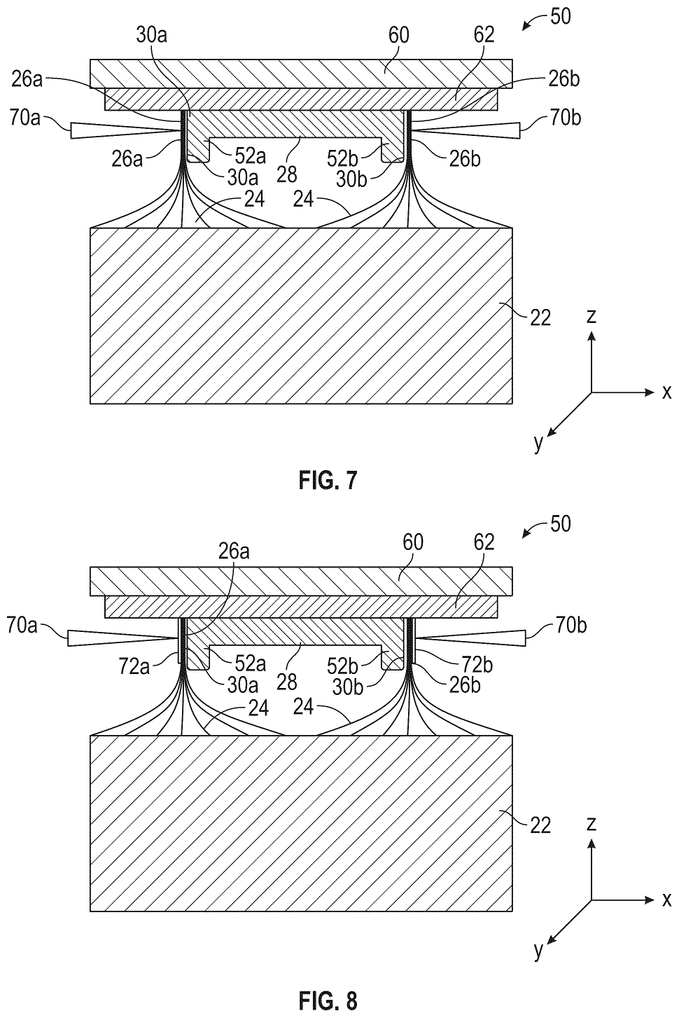

Referring to FIGS. 7 and 8, for example, the tab stacks 26a and 26b are joined to the surfaces 30a and 30b via a laser welding process. Laser welding is performed by applying a laser beam 70a to the tab stack 26a and the surface 30a, and simultaneously applying a laser beam 70b to the tab stack 26b and the surface 30b (or applying the laser beam 70b at another time if desired).

The tab stacks may be welded directly as shown in FIG. 7. Alternatively, as shown in FIG. 8, a conductive sheet or plate 72 (shown as plates 72a and 72b) is applied to each tab stack opposite a welding surface prior to welding. For example, the plate 72a is applied to the outermost layer of the tab stack 26a and the plate 72b is applied to the outermost layer of the tab stack 26b, thereby sandwiching each tab stack. Each plate 72a, 72b is welded with its respective tab stack.

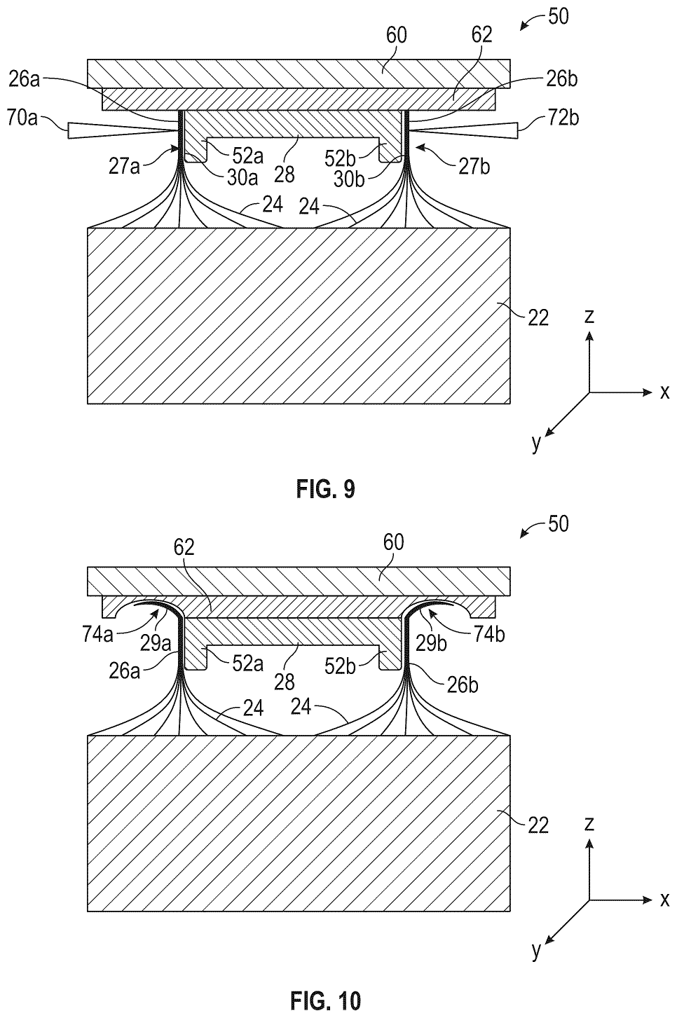

In another example, shown in FIG. 9, the tab stacks 26a and 26b are joined to the surfaces 30a and 30b via a combined laser and ultrasonic welding process. In this process, each tab stack 26a, 26b is first fused via ultrasonic welding (independent from the weld plate 28), resulting in a fused tab stack 27 (denoted as fused tab stacks 27a and 27b). The fused tab stacks 27a and 27b are subsequently welded to a respective surface 30a and 30b of the weld plate 28 via laser welding.

The methods described herein may include a variety of methods for collecting and/or removing excess tab portions or excess foil. Excess foil is defined as portions of the tabs above the welded tab stacks. For example, excess foil can be trimmed as discussed above, or collected so as not to interfere with operation of a completed battery cell.

FIG. 10 shows an embodiment of the connection assembly 50, which includes a diversion feature in the form of one or more recesses 74 formed in the isolation insert 62. Each recess may be formed exclusively within the isolation insert 62, formed within parts of both the isolation insert 62 and the cap plate 60, or otherwise formed in any suitable location or portion of the connection assembly 50.

For example, a recess 74a is formed at a location in the insert 62 adjacent to the weld plate 28, so that an excess portion 29a above the tab stack 26a is diverted along a curved path that extends generally perpendicular to the tab stack 26a. A recess 74b is similarly formed at a location in the insert 62 adjacent to the weld plate 28, so that an excess portion 29b above the tab stack 26b is diverted along a curved path. In this way, the excess portions 29a, 29b are diverted without introducing any folds or creases, and without interfering with subsequent welding of the flat tab stacks 26a and 26b.

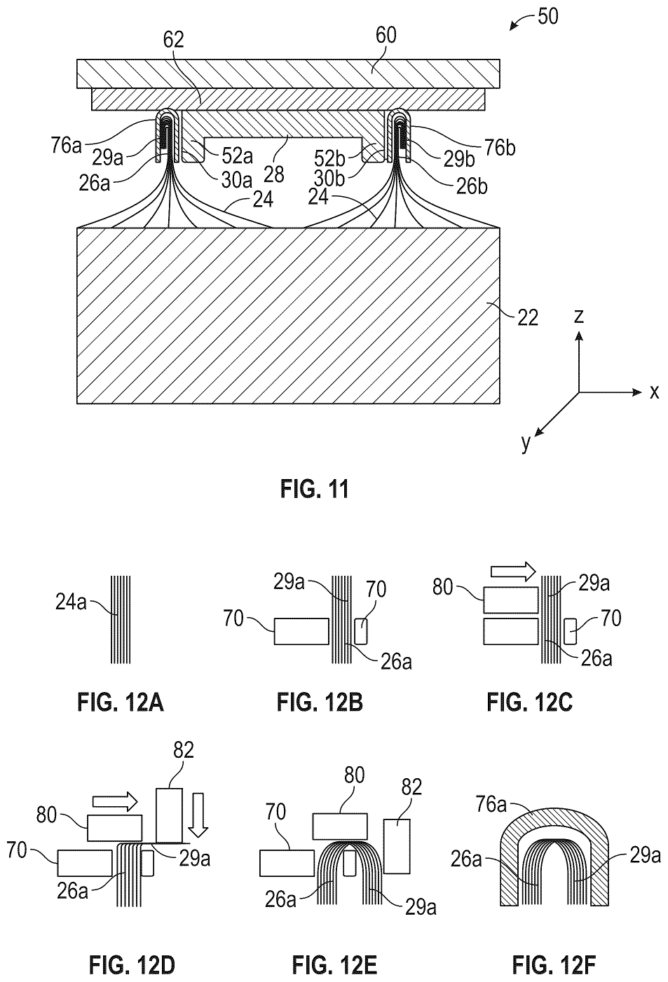

FIG. 11 shows an example in which the connection assembly 50 includes a diversion device 76 that diverts excess portions without folding or bending the tab stack portion subject to a weld. In this example, the diversion device 76 is a u-shaped clip 76 that can be used to divert an excess portion above a weld without the need to trim or crease the welded portion.

Each clip 76a, 76b may have any overall width (in the y-axis direction) that corresponds to the width of the tab stacks 26a, 26b, and a length (in the z-axis direction) that is equal to or similar to a length of the connection member 52a, 52b. Each clip 76a, 76b allows for excess foil to be diverted so that the excess portion forms a 180 degree u-shaped bend. Each clip 76a, 76b may be held in place (e.g., via the sonotrodes and/or other suitable device) during welding.

Each clip 76a, 76b may be held in place during the welding process, such that at least part of the clip 76a, 76b forms part of the weld. For example, the tab stack 26a and the clip 76a are held against the surface 30a (such that part of the clip 76a is sandwiched between the stack 26a and the surface 30a), and are welded together. The weld fuses both sides of a clip, the tab stack and weld plate surface together.

FIGS. 12A-12F illustrates aspects of a method of manufacturing a battery cell. The method of FIGS. 12A-12F may be incorporated as part of the method of FIGS. 6A-6F. For example, the steps described in conjunction with FIGS. 12A-12F may be performed in place of the trimming steps discussed herein.

The method (or parts thereof) may be performed by any suitable processing device or devices, such as one or more controllers of the manufacturing system 40 (e.g., the controller 49 connected to the welding station 48) and/or the connection system 50, but is not so limited.

The method includes a number of steps or stages. The method is not limited to the number or order of steps therein, as some steps may be performed in a different order than that described below, or fewer than all of the steps may be performed.

At a first stage, referring to FIG. 12A, portions of anode tabs 24 are collected as a tab stack 26. For example, the anode tabs 24 are partitioned into two sets of tabs 24a and 24b. Although only the set of tabs 24a and associated tab stack 26a is shown, it is understood that the other set of tabs 24b and the tab stack 26b are similarly processed.

At a second stage, referring to FIG. 12B, the tabs 24a are disposed with a bonding device, such as a gripper 70, and compressed to form a joined or compressed tab stack 26a. Portions of the tabs 24a above the gripper 70 are referred to as an excess portion 29a.

At a third stage, referring to FIG. 12C, a first force applicator 80, such as a laterally extendable plunger 80, is applied to the excess portion 29a to cause the excess portion 29a to extend laterally and form an angle that is approximately 90 degrees with respect to the tab stack 26a.

At a fourth stage, referring to FIG. 12D, a second force applicator 82, such as a vertically extendable plunger 82, is applied to the excess foil portion 29a to cause part of the excess portion 29a to bend vertically. In this way, a 180 degree bend is established and the excess portion 29a forms a u-shape with the tab stack 26a, as shown in FIG. 12E. The excess portion can thus be diverted in a gradual manner, without introducing any creases or folds.

At a fifth stage, referring to FIG. 12F, the clip 76a is slid over or otherwise disposed around the tab stack 26a and the excess portion 29a. The clip 76a functions to hold the tab stack 26a and the excess portion 29a in the u-shape.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for electrically connecting tabs of a battery cell, comprising:
an electrically conductive weld plate configured to be disposed within a housing of the battery cell and electrically connected to a tab stack formed from a plurality of tabs extending from electrode layers of a cell stack, the weld plate having a welding surface that is at least partially oriented along a vertical direction, the vertical direction parallel to a surface of electrode layers forming an electrode stack; and
a welding device configured to weld the tab stack to the welding surface and form at least part of a connector, wherein the tab stack is welded while maintaining the tab stack in a planar configuration and in an undeformed condition.

2. The system of claim 1, wherein the undeformed condition is a condition in which the tab stack is not folded prior to welding, and is not subject to bending forces during the welding.

3. The system of claim 1, wherein the welding device is configured to perform a welding method that includes at least one of ultrasonic welding and laser welding, the welding device including at least one of a laser welding device and an ultrasonic welding device, the ultrasonic welding device including an ultrasonic generator configured to engage the tab stack and the welding surface.

4. The system of claim 3, wherein the welding surface includes a textured pattern to facilitate fusion of the tab stack to the weld plate.

5. The system of claim 1, wherein the tab stack includes a first tab stack and a second tab stack formed from the plurality of tabs, and the welding surface includes a pair of opposing weld surfaces, each opposing weld surface configured to be used to weld one of the first tab stack and the second tab stack to the weld plate.

6. The system of claim 1, further comprising an actuator configured to move the weld plate in the vertical direction, the actuator being controllable to move the weld plate toward the cell stack in the vertical direction subsequent to welding, to relieve stress on portions of the plurality of tabs between the cell stack and the tab stack.

7. The system of claim 1, wherein the housing is a rigid housing.

8. The system of claim 1, further comprising a bonding device configured to engage the plurality of tabs and bond the plurality of tabs together in the planar configuration to form the tab stack.

9. A method of electrically connecting tabs of a battery cell, comprising:
acquiring a cell stack, the cell stack configured to be disposed in a housing to form the battery cell, wherein a plurality of tabs extend from electrode layers of the cell stack;
forming a tab stack from a portion of the plurality of tabs, and disposing the tab stack against a welding surface of a weld plate, the weld plate configured to be disposed within the housing, the welding surface at least partially oriented along a vertical direction, the vertical direction parallel to a surface of electrode layers forming an electrode stack; and
welding the tab stack to the welding surface by a welding device to form at least part of a connector, wherein the tab stack is welded while maintaining the tab stack in a planar configuration and in an undeformed condition.

10. The method of claim 9, wherein the undeformed condition is a condition in which the tab stack is not folded prior to welding, and is not subject to bending forces during the welding.

11. The method of claim 9, wherein the welding device is configured to perform a welding method that includes at least one of ultrasonic welding and laser welding, the welding device including at least one of a laser welding device and an ultrasonic welding device, the ultrasonic welding device including an ultrasonic generator configured to engage the tab stack and the welding surface.

12. The method of claim 11, wherein the welding surface includes a textured pattern to facilitate fusion of the tab stack to the weld plate.

13. The method of claim 9, wherein the tab stack includes a first tab stack and a second tab stack formed from the plurality of tabs, the welding surface includes a pair of opposing weld surfaces, and welding the tab stack includes welding the first tab stack to one of the pair of opposing surfaces and welding the second tab stack to another of the pair of opposing surfaces.

14. The method of claim 9, further comprising moving the weld plate toward the cell stack in the vertical direction subsequent to welding, to relieve stress on portions of the plurality of tabs between the cell stack and the tab stack.

15. The method of claim 9, further comprising diverting an excess portion of the plurality of tabs, the excess portion including portions of each tab above the welded tab stack, wherein the diverting includes applying a curvature to the excess portion.

16. A computer program product comprising a computer-readable memory that has computer-executable instructions stored thereupon, the computer-executable instructions when executed by a processor cause the processor to perform operations comprising:
acquiring a cell stack, the cell stack configured to be disposed in a housing to form a battery cell, wherein a plurality of tabs extend from electrode layers of the cell stack;
forming a tab stack from a portion of the plurality of tabs, and disposing the tab stack against a welding surface of a weld plate, the weld plate configured to be disposed within a housing of the battery cell, the welding surface at least partially oriented along a vertical direction, the vertical direction parallel to a surface of electrode layers forming an electrode stack; and
welding the tab stack to the welding surface by a welding device to form at least part of a connector, wherein the tab stack is welded while maintaining the tab stack in a planar configuration and in an undeformed condition.

17. The computer program product of claim 16, wherein the undeformed condition is a condition in which the tab stack is not folded prior to welding, and is not subject to bending forces during the welding.

18. The computer program product of claim 16, wherein the welding device includes an ultrasonic welding device, including an ultrasonic generator configured to engage the tab stack and the welding surface, and the welding surface includes a textured pattern to facilitate fusion of the tab stack to the weld plate.

19. The computer program product of claim 16, wherein the operations include moving the weld plate toward the cell stack in the vertical direction subsequent to welding, to relieve stress on portions of the plurality of tabs between the cell stack and the tab stack.

20. The computer program product of claim 16, wherein the operations include engaging the plurality of tabs by a bonding device, and bonding the plurality of tabs together in the planar configuration to form the tab stack prior to welding.
